(19) United States
(12) Patent Application Publication
(10) Pub. No.: US 2011/0010880 A1
(43) Pub. Date: Jan. 20, 2011

(54) TOILET BRUSH WITH LIFTING ARMS

(76) Inventor: Roosevelt Smith, JR., Cleveland, OH (US)

Correspondence Address: HOWARD M COHN;PATENT ATTORNEY LLC, 21625 CHAGRIN BLVD #220, CLEVELAND, OH, 44122, US

(21) Appl. No.: 12/836,272

(22) Filed: Jul. 14, 2010

Related U.S. Application Data
(60) Provisional application No. 61/225,246, filed on Jul. 14, 2009.

(51) Int. Cl. A46B 9/02; B25G 1/10

(52) U.S. Cl. 15/160; 15/143.1

(57) ABSTRACT

An apparatus for cleaning an enclosure having a lid has a cleaning element. The apparatus also has a handle connected to the cleaning element. A lifting arm, mounted on the handle, is configured to lift the lid.

### CROSS-REFERENCE TO RELATED APPLICATIONS

This application claims the benefit of U.S. Provisional Patent Application No. 61/225,246 filed on Jul. 14, 2009 which is incorporated herein by reference.

### TECHNICAL FIELD

The present invention relates generally to a cleaning apparatus designed to lift a lid of an enclosure before cleaning the enclosure, and more particularly to a toilet brush design to lift the toilet seat and cover of a toilet before cleaning the toilet.

### BACKGROUND OF THE INVENTION

Cleaning can often be a dirty business, and rarely more so when the object being cleaned is a toilet. Toilet brushes, which usually consist of a bristled brush mounted on a short stick, makes this task both easier and more sanitary. Such devices allow a person to scrub the inside of a toilet bowl without needing to reach into the howl or come into direct contact with the dirty surfaces.

An ordinary toilet brush, however, does not obviate contact with all the potentially dirty surfaces into which one might come in contact while cleaning. In order to access the inside of the toilet bowl, one must still manually lilt the toilet seat and cover. The underside of the toilet seat and cover are likely to be filthy and germ-laden.

Wearing cleaning gloves, often made of rubber or latex, provides one solution to this problem. These gloves shield a cleaner's hands from dirty surfaces and can themselves be cleaned or thrown away after the cleaning task is finished. Wearing gloves presents a fresh host of complications too. Gloves can inhibit the maneuverability of the wearer.

Also, the filth may simply he transferred from the bowl to the gloves. where it is eventually touched as the wearer takes off, disposes of or cleans the gloves. Additionally, wearing gloves, particularly of impermeable material like rubber, can become uncomfortable and balmy, especially if worn over a long period of time.

The present invention provides a practical and elegant solution to this problem.

### SUMMARY OF THE INVENTION

In an aspect of the present invention, an apparatus for cleaning an enclosure having a lid has a cleaning element. The cleaning apparatus has a handle connected to the cleaning element. The cleaning apparatus also has a lifting arm mounted on the handle. The lifting arm is configured to lift the lid.

In another aspect of the present invention, a detachable apparatus has a hollow cylinder and a lifting arm mounted on the hollow cylinder. The lilting arm is configured to lift a lid of an associated enclosure. The hollow cylinder is configured to wrap around a handle of an associated cleaning apparatus.

In another aspect of the present invention, a method of cleaning an enclosure having a lid is provided. A lifting arm of an associated cleaning apparatus is engaged with the lid. The lid is opened by lifting the cleaning apparatus. The enclosure is cleaned with a cleaning element of the associated cleaning apparatus.

### BRIEF DESCRIPTION OF DRAWINGS

FIG. 1 is a perspective view showing an entire embodiment of the invention with two lifting arms, one curved and one straight.

FIG. 2 shows a detailed view of embodiment of the lifting arm with a rubber covering.

FIG. 3 shows a detailed view of another embodiment of the lifting arm with ridges.

FIG. 4 shows a detailed view of a lilting arm that does not feature any grip enhancing element.

FIG. 5 shows a detailed view of a lifting arm engaging a toilet seat to raise it into an open position.

FIG. 6 shows a detailed view of a lifting arm engaging the seat to move it into a closed position.

FIG. 6a shows a detailed view of the curved lifting arm looping through the curved portion on the opening around a toilet seat to position the seat in a closed position.

FIG. 7 shows a perspective view of an embodiment of the invention employing a detachable arm apparatus.

FIG. 8 shows a detailed frontal view of an embodiment of the invention employing a detachable arm apparatus.

FIG. 9 shows a detailed rear view of an embodiment of the invention employing a detachable arm apparatus.

FIG. 10 shows a detailed top view or the detachable arm apparatus.

### DETAILED DESCRIPTION OF PREFERRED EMBODIMENTS

The present invention contemplates an apparatus for cleaning an enclosure having a lid. The apparatus has a cleaning element and a handle connected to the cleaning element. A lifting arm is mounted on the handle. The lifting arm is configured to lift the lid. In one example, the cleaning element comprises a brush head. It is also within the terms of the present invention for the cleaning element to comprise a brush pad, a spray nozzle, or other suitable element for cleaning an enclosure.

In an example embodiment, the apparatus comprises a second lifting arm mounted on the handle opposite the lifting arm. In one example, the lifting arm is straight while the second lifting arm is curved. It is also within the terms of the present invention for the lifting arm to be curved while the second lifting arm is straight, for both lifting arms to be straight, or for both lifting arms to be curved.

In an example embodiment, the lilting arm comprises a rubber sheath. In another example, the lifting arm comprises a plurality of ridges. It is also within the terms of the present invention for the lifting arm to comprise any suitable material to enhance traction between the lifting arm and the lid of the enclosure.

In an example embodiment, the lifting arm is detachable. For example, the lifting arm may be separated from the handle. A detachable lilting arm may allow for easier storage of the cleaning apparatus.

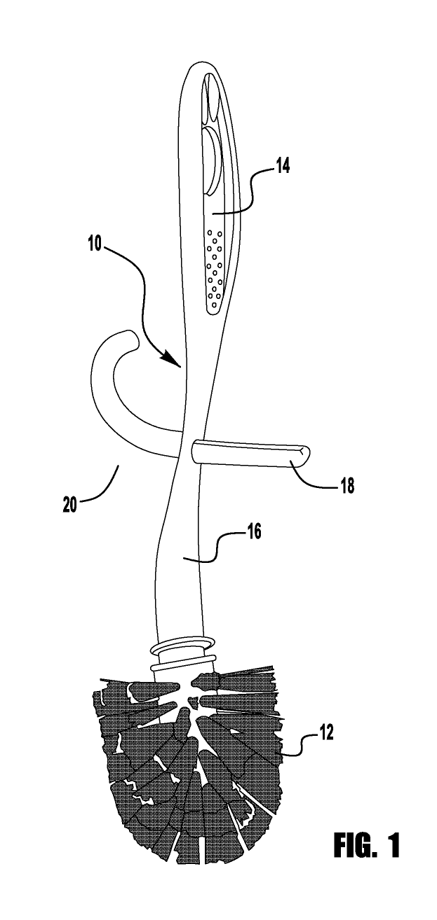

Referring to the drawings, FIG. 1 illustrates one embodiment of the invention. It shows a toilet brush 10, with a brush head 12 at one end and a handle 14 at the other end. The two ends are joined by a shaft-like base 16. The brush head 12 is used to scrub the inside of a toilet howl while the user holds and controls the movements of the brush with the handle 14. Attached to the base 16 are an anterior straight lifting arm 18 and a posterior curved lifting arm 20 adapted for opening and closing the cover and toilet seat associated with a toilet.

It is also within the terms of the present invention for the anterior lifting arm 18 to be curved and for the posterior lilting arm 20 to be straight. It is also within the terms of the present invention for both the anterior lifting arm 18 and the posterior lifting arm 20 to be straight or to be curved.

Typically, the toilet brush 10 is formed of plastic. It is also within the terms of the invention to form the brush 10 of any other suitable material such as wood or metal.

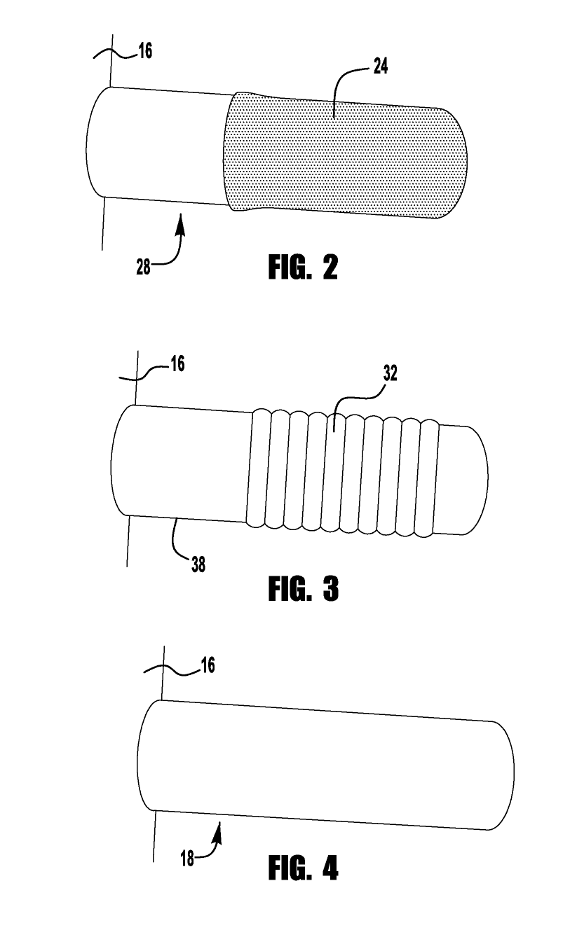

FIGS. 2-4 show different embodiments of the lifting arm. FIG. 2 shows an embodiment of the straight lifting arm 28 (compare with arm 18), covered with a rubber sheath 24. The rubber sheath 24 enhances traction between the lifting arm 28 and the toilet seat, and prevents slippage.

FIG. 3 shows another embodiment of the invention wherein the straight lifting arm 38 has a roughened surface, such as ridges 32 formed in the surface of the lifting arm. These ridges 32, like the rubber sheath 24 in the embodiment shown in FIG. 2, are intended to increase traction between the lifting arm 38 and the toilet seat.

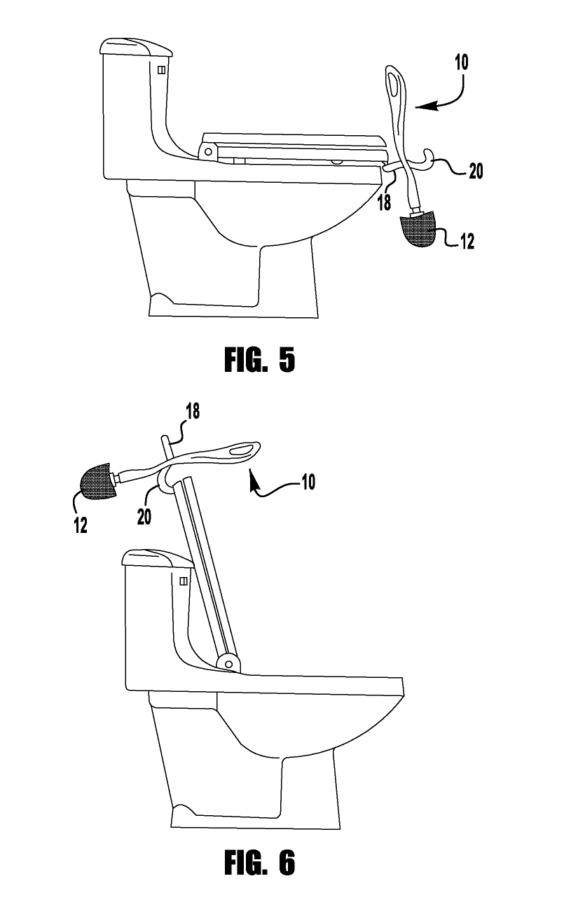

FIG. 4 shows an embodiment of the lifting arm 18 of FIG. 1 with no additional structural components to increase traction.

The posterior curved lifting arm 20, as with the straight lifting arm 18, can be constructed with a rubber sheath or ridges to increase traction between the lifting arm 20 and the toilet seat.

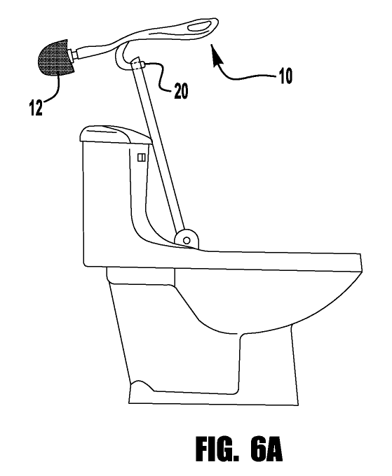

FIGS. 5-6 show the invention in use. FIG. 5 illustrates the toilet brush 10 engaging its straight lifting arm 18, or any of the embodiments described herein, to open a toilet seat at the start of cleaning. FIG. 6 shows the curved lifting arm 20 being used to close the toilet seat after cleaning.

FIG. 6a shows the curved lifting arm 20 looping through the curved portion on the opening around a toilet seat, to form a hooked engagement with the toilet seat and maintain maximum control of the position of the seat as it is moved into the closed position. Note that only one arm is being used in this embodiment. It is also within the terms of the invention for the single arm of this embodiment to be the straight arm or the curved arm.

It is also within the terms of the invention to use the toilet brush 10 engaging its straight lifting arm 18, with any of the embodiments described herein, to open a toilet seat at the start of cleaning. Moreover, it is also within the terms of the invention to use the toilet brush 10 engaging its curved lifting arm 20, with any of the embodiments described herein, to the curved portion on the opening around the seat, in order to close the toilet seat, at the end of cleaning.

In a second embodiment, the present invention contemplates a detachable apparatus comprising a hollow cylinder and a lifting arm mounted to the hollow cylinder. The lifting arm is configured to lift a lid of an associated enclosure. The hollow cylinder is configured to wrap around a handle of an associated cleaning device.

In an example embodiment, the detachable apparatus comprises a second titling arm mounted on the hollow cylinder opposite the lifting arm. In one example, the lifting arm is straight while the second lifting arm is curved. It is also within the terms of the present invention for the lifting arm to be curved while the second lifting arm is straight, for both lifting arms to be straight, or for both filling arms to be curved.

In an example embodiment, the lifting arm comprises a rubber sheath. In another example, the lifting arm comprises a plurality of ridges. It is also within the terms of the present invention for the lifting arm to comprise any suitable material to enhance traction between the lifting arm and the lid of the enclosure.

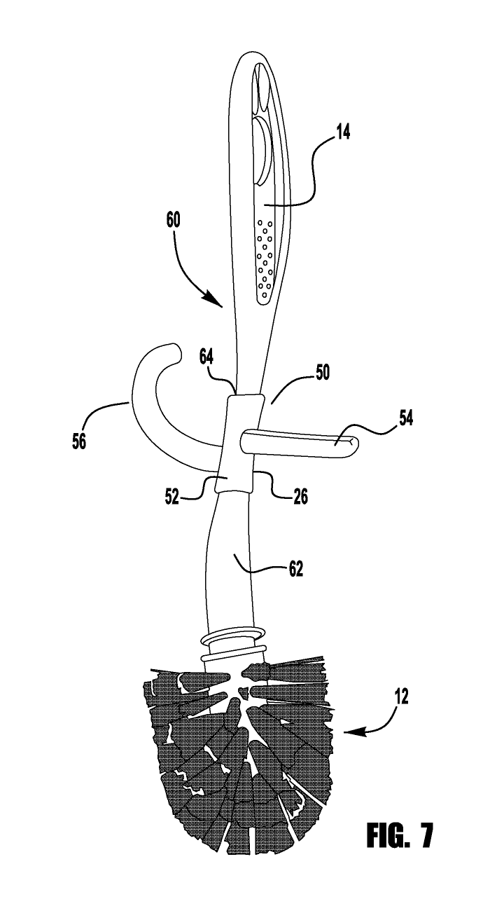

FIGS. 7-9 show another embodiment of the invention wherein a detachable apparatus component 50 is constructed of a hollow cylinder 52 having an interior shape adapted to grip the base 62 having an anterior straight lifting arm 54 (compare with arm 18) and a posterior curved lifting arm 56 (compare with arm 20) adapted for opening and closing the cover and toilet seat associated with a toilet.

Referring to FIG. 8, detachable apparatus component 50 is constructed of a hollow cylinder 52 which can be attached to the base 62 of a toilet brush 60. In this embodiment, the lifting arms 54 and 56 are affixed to the base 62 by means of a detachable apparatus 50, rather than permanently joined. This embodiment allows the present invention to be practiced with preexisting toilet brushes, simply by snapping on the illustrated attachment.

FIG. 8 shows a detailed view of this mechanism, with the detachable apparatus 50 adapted to wrap around the base 62. Within the present invention, the base 62 may or may not be modified from an ordinary toilet brush base to conform to the shape of the detachable apparatus. It is also within the terms of the invention to form the apparatus 50 of one piece of a hollow cylinder that can slip onto a cylindrically shaped handle. At one end of the detachable apparatus 50, an attachment means 58 can connect a first elongated edge 52a and a second elongated edge 52h and hold the elongated edges 52a, 52b together after the apparatus has been mounted onto the base 62 of the toilet brush. The attachment means 58 can be configured to release the first elongated edge 52a from the second elongated edge 52b to remove the apparatus 50 as needed.

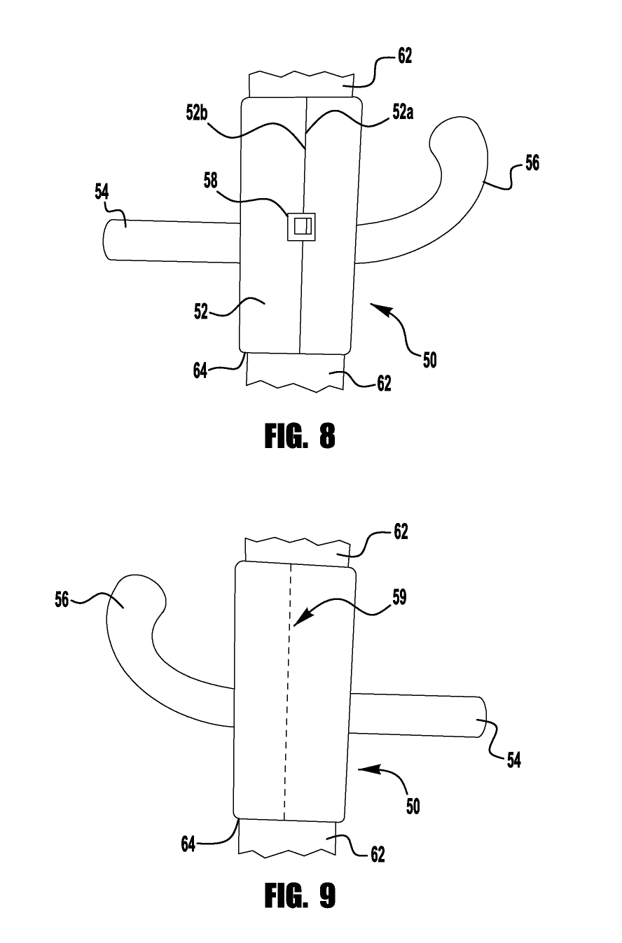

FIG. 9 shows the reverse side of the detachable apparatus 50, whereby a fold or hinge 59 facilitates the easy release of the apparatus from the base 16.

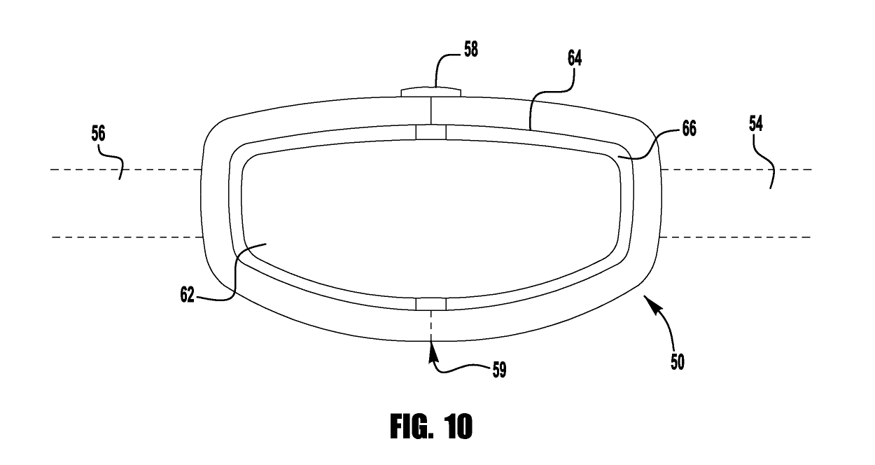

FIG. 10 illustrates the detachable apparatus 10 seen from the top. In this embodiment, the interior surface 64 of the detachable apparatus 50 can be fitted with a layer of foam 66, or other expandable material, so the interior of the apparatus will make close contact with a variety of differently shaped bases 62.

In a method of cleaning an enclosure having a lid. An engaging arm of an associated cleaning apparatus is engaged with the lid. The lid is opened by lifting the cleaning apparatus. The enclosure is cleaned with a cleaning element of the associated cleaning apparatus. The lid of the enclosure is closed by lowering the cleaning apparatus after the enclosure has been cleaned.

In an example embodiment, the method further comprises engaging a second lifting arm of the associated cleaning apparatus with the lid and closing the lid by lowering the cleaning apparatus.

In an example embodiment, the enclosure is a toilet. It an example embodiment, engaging the lifting arm of the associated cleaning apparatus with the lid comprises looping a curved lifting arm of the associated cleaning apparatus through a curved portion of an opening of the associated toilet seat to form a hooked engagement with the toilet seat.

While the present invention contemplates cleaning a toilet with the cleaning apparatus, it is also within the terms of the present invention for the cleaning apparatus to be adapted to clean other suitable enclosures.

It is also understood, of course, that while the form of the invention herein shown and described constitutes a preferred embodiment of the invention, it is not intended to illustrate all possible forms thereof. It will also be understood that the words used are words of description rather than limitation, and that various changes may be made without departing from the spirit and scope of the invention disclosed. Thus, the scope of the invention should be determined by the appended claims and their legal equivalents, rather than solely by the examples given.

What is claimed is:

1. An apparatus for cleaning an enclosure having a lid, the apparatus comprising:
a cleaning element;
a handle connected to the cleaning element; and
a lifting arm mounted on the handle, configured to lift the lid.

2. The apparatus of claim 1, wherein the cleaning element comprises a brush head.

3. The apparatus of claim 1 further comprising a second lifting arm mounted on the handle opposite the lifting arm.

4. The apparatus of claim 3, wherein the lifting arm is straight and wherein the second lifting arm is curved.

5. The apparatus of claim 1, wherein the lifting arm is at least partially covered with a rubber sheath.

6. The apparatus of claim 1, wherein the lifting arm includes a plurality of ridges along its length.

7. The apparatus of claim 1, wherein the lifting arm is detachable.

8. A detachable apparatus comprising:
a hollow cylinder; and
a lifting arm mounted on the hollow cylinder configured to lift a lid of an associated enclosure;
wherein the hollow cylinder is configured to wrap around a handle of an associated cleaning apparatus.

9. The detachable apparatus of claim 8, further comprising a second lifting arm mounted on the hollow cylinder opposite the lifting arm.

10. The detachable apparatus of claim 9, wherein the lifting arm is straight and the second lifting arm is curved.

11. The detachable apparatus of claim 8, wherein the lifting arm is at least partially covered with a rubber sheath.

12. The detachable apparatus of claim 8, wherein the lifting arm includes a plurality of ridges along its length.

13. The detachable apparatus of claim 8, wherein the hollow cylinder comprises:
a first elongated edge;
a second elongated edge; and
an attachment element configured to connect the first elongated edge to the second elongated edge.

14. The detachable apparatus of claim 13, wherein the attachment element is configured to release the first elongated edge from the second elongated edge.

15. The detachable apparatus of claim 13, wherein the hollow cylinder further comprises a hinge disposed opposite the attachment element, to facilitate the release of the detachable apparatus from the associated cleaning apparatus.

16. The detachable apparatus of claim 8, further comprising an expandable material mounted to an interior surface of the hollow cylinder to facilitate contact of the hollow cylinder with the associated cleaning apparatus.

17. A method of cleaning an enclosure having a lid comprising the steps of
engaging a lifting arm of an associated cleaning apparatus with the lid;
opening the lid by lifting the cleaning apparatus; and
cleaning the enclosure with a cleaning element of the associated cleaning apparatus.

18. The method of claim 17, further comprising:
engaging a second lifting arm of the associated cleaning apparatus with the lid; and
closing the lid by lowering the cleaning apparatus.

19. The method of claim 17 wherein the enclosure is a toilet and wherein the lid is a toilet seat.

20. The method of claim 19, wherein engaging the lifting arm of the associated cleaning apparatus with the lid comprises looping a curved lifting arm of the associated cleaning apparatus through a curved portion of an opening of the associated toilet seat to form a hooked engagement with the toilet seat.
